(19) United States
(12) Patent Application Publication
(10) Pub. No.: US 2026/0266234 A1
(43) Pub. Date: Sep. 10, 2026

(54) ENGINE CONTROL DEVICE AND ENGINE FUEL CONTROL DEVICE

(71) Applicants: YAMABIKO CORPORATION, Tokyo (JP); Oppama Industry Co., Ltd., Kanagawa (JP)

(72) Inventors: Minoru KUROIWA, Tokyo (JP); Ryosuke IMAI, Tokyo (JP); Ryosuke KAJIYAMA, Kanagawa (JP)

(21) Appl. No.: 19/162,400

(22) PCT Filed: Mar. 8, 2024
(86) PCT No.: PCT/JP2024/009033

§ 371 Date: Sep. 5, 2025

(30) Foreign Application Priority Data
Mar. 13, 2023 (JP) 2023-038450

(51) Int. Cl. F02D 41/06; F02P 5/04

(52) U.S. Cl. CPC F02D 41/062; F02P 5/045; F02D 2200/021

(57) ABSTRACT

An engine control device and a fuel control device that perform fuel control for an engine configured to include a first thermistor that is disposed at a location susceptible to the engine temperature and detects a first detection temperature, a second thermistor that is disposed at a location less susceptible to the engine temperature and detects a second detection temperature, and a control unit that performs the fuel control for the engine based on a deviation between the first detection temperature and the second detection temperature. This prevents execution of start assist when start assist is unnecessary, such as during the engine operation or immediately after the engine shutdown.

### TECHNICAL FIELD

The present invention relates to an engine control device and a fuel control device that perform fuel control for an engine.

### BACKGROUND ART

As an engine control device, a start control device that executes start assist for an engine is known as one form of a fuel control device that performs fuel control for the engine.

As a conventional start control device that executes start assist for an engine, for example, a start control device is known including an electromagnetic valve that is disposed in a fuel supply passage for supplying fuel from a fuel tank to the engine in a bypass manner and is opened and closed by a magnetic coil at the time of starting the engine, a temperature detection unit that detects a temperature of the engine, a rotational speed detection unit that detects a rotation speed of the engine, and a control unit that controls the opening and closing of the electromagnetic valve based on the detected temperature and rotation speed (see, for example, Patent Literature 1).

Patent Literature 1: JP H03-35247 U1

In the engine including the start assist device as described above, the starting performance of the engine is improved by increasing the amount of fuel or advancing the ignition timing based on the detected temperature.

However, there was a problem in that the start assist was executed even when it was unnecessary, such as during the engine operation or immediately after the engine shutdown.

That is, the start assist is obviously unnecessary during the engine operation, and even when the engine is started immediately after the engine shutdown, the start assist is unnecessary since the engine is already in a warmed-up state. Nevertheless, conventionally, there was a possibility that the start assist would be automatically executed when the ignition switch was operated to initiate the engine start even during the engine operation or immediately after the engine shutdown.

### Disclosure of Invention

The present invention has been made in view of the above-described conventional problem, and an object is to provide an engine control device and a fuel control device that can reliably prevent unnecessary execution of start assist and enable more precise adjustment with a simple configuration.

In order to achieve the object, an engine control device that performs fuel control for an engine according to the present invention is characterized by including at least two temperature detection means disposed on a control board for engine fuel control.

Further, a fuel control device that performs fuel control for an engine according to the present invention is characterized by including: a first temperature detection means that is disposed at a location susceptible to a temperature of the engine and detects a first detection temperature; a second temperature detection means that is disposed at a location less susceptible to the temperature of the engine and detects a second detection temperature; and a control means that performs fuel control for the engine based on a relationship between the first detection temperature and the second detection temperature. The first temperature detection means and the second temperature detection means are disposed apart from each other on a control board for engine fuel control.

According to the present invention, in the engine control device and the engine fuel control device, the execution of the start assist when the start assist is unnecessary, such as during the engine operation or immediately after the engine shutdown, can be reliably prevented. In addition, since the timing and the control amount of the fuel control or those of the ignition timing control can be adjusted based on detection values, more precise engine control can be achieved.

### BRIEF DESCRIPTION OF DRAWINGS

FIG. 1 is a schematic configuration diagram of an engine including a start control device according to an embodiment of the present invention.

FIG. 2 is a schematic configuration plan view of a control board of a magnetic coil of a start control solenoid illustrated in FIG. 1.

FIG. 3 is a graph showing regions where start assist is executed and stopped, based on a first detection temperature detected by a first thermistor and a second detection temperature detected by a second thermistor illustrated in FIGS. 1 and 2.

FIG. 4 is a flowchart of a control operation of the start assist according to the embodiment of the present invention in the start control device illustrated in FIG. 1.

### DESCRIPTION OF EMBODIMENTS

Hereinafter, an engine control device and an engine fuel control device according to the present invention will be described in detail with reference to the drawings.

In this embodiment, a start control device that executes start assist for an engine is described as one form of the engine control device and the fuel control device that performs fuel control for the engine. However, as described below, the present invention can be applied not only to the start control device, but also to an engine control device and a fuel control device other than the start control device.

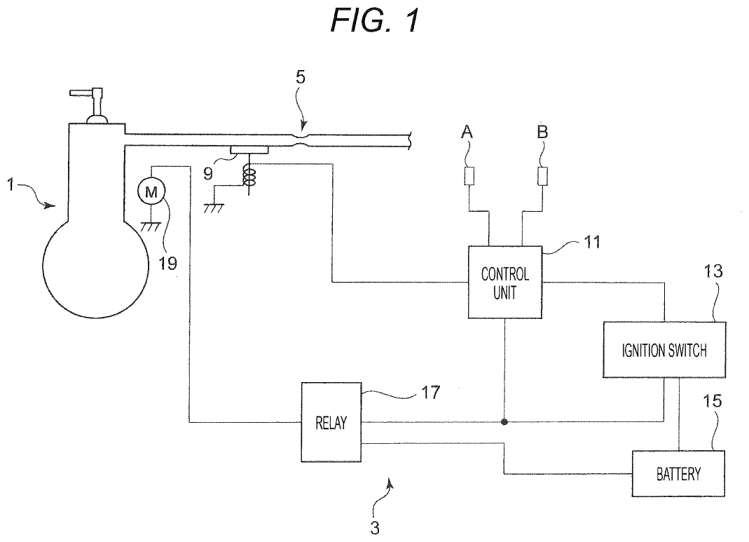

FIG. 1 is a schematic configuration diagram of an engine including a start control device according to an embodiment of the present invention.

In FIG. 1, a start control device 3 that executes start assist for an engine 1 according to an embodiment of the present invention includes a start control solenoid 9 that operates a start control valve of a carburetor 5 to be opened and closed to execute the start assist, a first thermistor (temperature detection means) A that is disposed at a location susceptible to the temperature of the engine 1 and detects a first temperature, a second thermistor (temperature detection means) B that is disposed at a location less susceptible to the temperature of the engine 1 and detects a second temperature, and a control unit (control means) 11 that controls the start control solenoid 9 based on a relationship between the first detection temperature from the first thermistor A and the second detection temperature from the second thermistor B.

In addition, an ignition switch 13 is connected to the control unit 11, and a starter motor 19 is provided between the control unit 11 and the ignition switch 13 via a battery 15 and a relay 17.

Note that the configuration operation around the carburetor 5 and the start control valve that execute the start assist is a well-known technique, and thus detailed illustration and description thereof will be omitted.

Then, in response to the operation of the ignition switch 13, the starter motor 19 is driven by the battery 15 and the relay 17 to initiate the start of the engine 1. At the same time, the control unit 11 controls the execution and stopping of the start assist as fuel control, as will be described below.

That is, the control unit 11 determines the latest operation state of the engine 1, and controls the start assist on the basis of the determined operation state of the engine 1. Therefore, the control unit 11 may be configured with a dedicated control circuit composed of a plurality of elements and the like. Alternatively, the control unit 11 may be composed of a CPU, RAM, and ROM, and configured to control the start assist based on a program stored in the ROM.

Here, the location where the first thermistor A is disposed, which is susceptible to the temperature of the engine 1, is close to the engine 1, which serves as a heat source. In contrast, the location where the second thermistor B is disposed, which is less susceptible to the temperature of the engine 1, is farther from the engine 1 than the location where the first thermistor A is disposed.

That is, the first thermistor A is disposed at a location closer to the engine 1 than the second thermistor B is.

In contrast, the second thermistor B is disposed at a location farther from the engine 1 than the first thermistor A is.

In other words, a first distance between the first thermistor A and the engine 1 is shorter than a second distance between the second thermistor B and the engine 1.

Specific examples of the disposition of the first thermistor A and the second thermistor B will be described below.

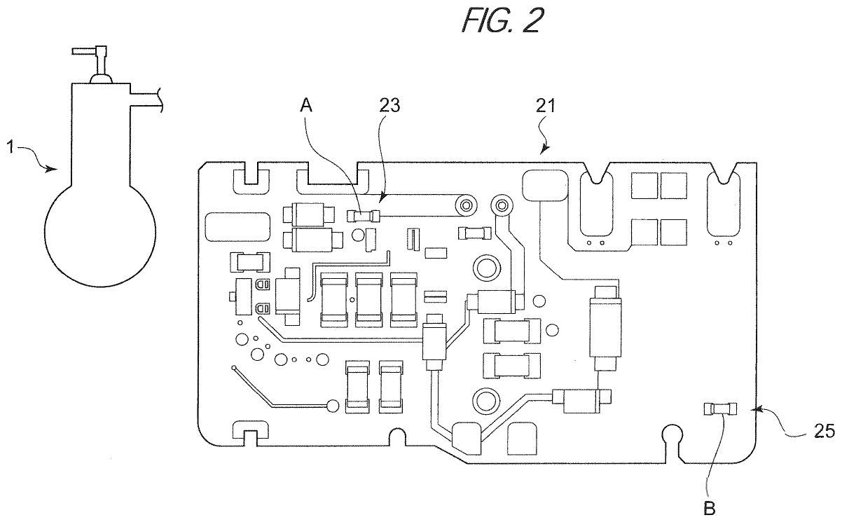

FIG. 2 is a schematic configuration plan view of a control board 21 of a magnetic coil of the start control solenoid 9 illustrated in FIG. 1. The elements and the like of the control unit 11 are mainly disposed on the control board 21, and the first thermistor A and the second thermistor B are disposed apart from each other.

As a specific example, the first thermistor A is disposed at a location 23 of the control board 21 of the magnetic coil of the start control solenoid 9 that is susceptible to the temperature of the engine 1, and the second thermistor B is disposed at a location 25 of the control board 21 of the magnetic coil that is less susceptible to the temperature of the engine 1.

This disposition causes a difference in detection values between the two thermistors depending on the operating condition of the engine. For example, immediately after starting the engine in a cold state, the first thermistor A is quickly affected by the engine and detects a relatively high temperature. However, the detection value from the second thermistor B, which is located farther away, is lower because the second thermistor B is not immediately affected by the engine.

This results in a difference between the detection values. On the other hand, when the engine is restarted after running for a sufficient time, the difference between the detection values of the first thermistor A and the second thermistor B becomes small or zero because the engine itself is warmed up and its heat has reached the second thermistor B, located farther away. When the temperature difference between the first thermistor A and the second thermistor B is small, the engine is considered sufficiently warmed up, and therefore the start assist amount is reduced or stopped.

Based on the temperature difference, the control unit 11 can determine whether to perform the ignition timing control and adjust the degree of advance.

Furthermore, by combining this with the fuel control, more precise start control can be achieved. That is, when the temperature difference becomes less than or equal to a predetermined value, the control unit 11 can reduce the amount of the ignition timing advance or switch to ignition in a normal ignition timing mode.

Details will be described below.

As illustrated in FIG. 2, the first thermistor A is disposed on an upper left side of the control board 21 as the location 23 of the control board 21 that is susceptible to the temperature of the engine 1. On the other hand, the second thermistor B is disposed on a lower right side of the control board 21 as the location 25 of the control board 21 that is less susceptible to the temperature of the engine 1.

As described above, the control board 21 is disposed such that the upper left side is close to the engine 1 and the lower right side is far from the engine 1.

Then, the control unit 11 controls the start control solenoid 9 so as to stop the start assist for the engine 1 when the relationship between the first detection temperature from the first thermistor A and the second detection temperature from the second thermistor B is in a state described below.

That is, the control unit 11 controls the start control solenoid 9 so as to stop the start assist for the engine 1 when the deviation between the first detection temperature from the first thermistor A and the second detection temperature from the second thermistor B is less than or equal to a setting value X.

This is expressed by the formula “first detection temperature TempA by first thermistor A-second detection temperature TempB by second thermistor B >setting value X”. Note that the setting value X is changed in accordance with the temperature based on the first thermistor A in consideration of a difference in temperature rise caused by the environmental temperature.

Here, the setting value X is mainly set based on installation locations of the first thermistor A and the second thermistor B. The deviation between the first detection temperature and the second detection temperature that satisfies the execution conditions for the start assist is obtained in advance on the basis of the installation locations of the first thermistor A and the second thermistor B, and the setting value X is determined on the basis of the obtained temperature deviation. Note that, in the present embodiment, the setting value X is set to 20 (20 degrees).

Note that, the execution conditions for the start assist refer to situations other than during the engine operation or immediately after the engine shutdown, and change depending on the types and structures of the start control device 3 and the engine 1.

As described above, the control unit 11 is configured to control whether to perform the start assist as the fuel control on the basis of the deviation between the first detection temperature and the second detection temperature, and can perform more accurate control according to the engine state.

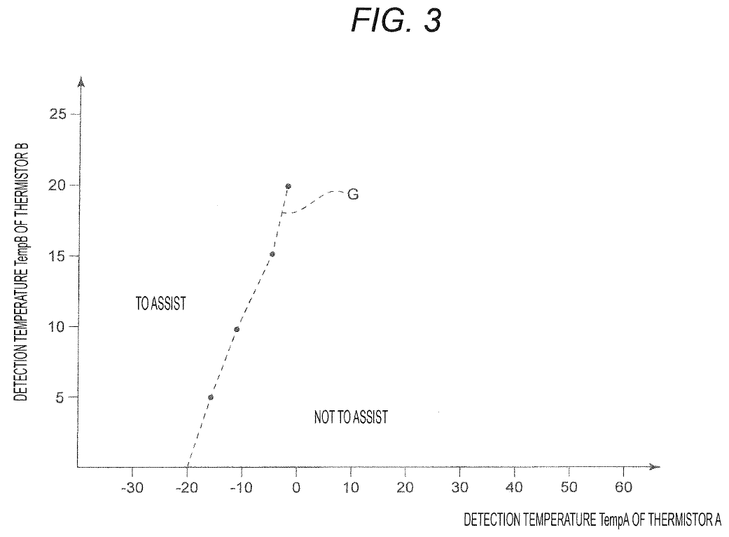

FIG. 3 is a graph showing the regions where the start assist is executed and stopped based on the first detection temperature TempA detected by the first thermistor A and the second detection temperature TempB detected by the second thermistor B.

As illustrated in FIG. 3, a line graph G is a graph when the deviation between the first detection temperature TempA and the second detection temperature TempB is 20 degrees. The region on the right side of the line graph G is the stop region of the start assist, and the region on the left side is the execution region of the start assist.

For example, in a case where the first detection temperature TempA is −10 degrees and the second detection temperature TempB is 5 degrees, the deviation is 15 degrees. As illustrated in FIG. 3, since this deviation falls within the stop region for the start assist on the right side of the line graph G, the start assist for the engine 1 is stopped. On the other hand, in a case where the first detection temperature TempA is −10 degrees and the second detection temperature TempB is 15 degrees, the deviation is 25 degrees. As illustrated in FIG. 3, since this deviation falls within the execution region for the start assist on the left side of the line graph G, the start assist for the engine 1 is executed.

In this graph, only the switching between the execution and the stop is performed, but the amount of fuel to be supplied may be set in stages within the execution region. For example, by providing an intermediate control region between the execution and the stop and setting the start assist fuel to half, it is possible to perform more precise control.

Note that, as described above, the control unit 11 may be configured using a microcomputer including RAM, ROM, and a CPU. In this case, the control unit 11 may perform control of a start assist operation, which will be described below, through arithmetic processing by the CPU using the RAM on the basis of a predetermined program stored in the ROM. Alternatively, the control unit 11 may be configured with a dedicated control circuit.

With the above configuration, the first thermistor (temperature detection means) A that detects the first detection temperature is disposed at a location susceptible to the temperature of the engine 1, and the second thermistor (temperature detection means) B that detects the second detection temperature is disposed at a location less susceptible to the temperature of the engine 1. Since the control unit 11 controls the start assist on the basis of the relationship between the first detection temperature and the second detection temperature, it is possible to reliably prevent the unnecessary execution of the start assist with a simple configuration.

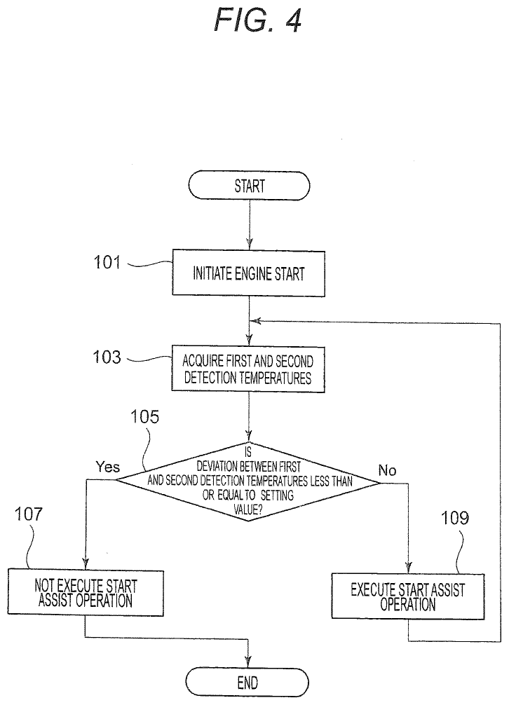

Next, a control operation of start assist according to the embodiment of the present invention in the start control device illustrated in FIG. 2 will be described with reference to the flowchart of FIG. 4. FIG. 4 is a flowchart of a control operation of start assist according to the embodiment of the present invention in the start control device illustrated in FIG. 2.

In step 101 of FIG. 4, when the start of the engine 1 is initiated by the ignition switch 13, in step 103, the control unit 11 of the start control device 3 acquires the first detection temperature detected by the first thermistor A and the second detection temperature detected by the second thermistor B.

In step 105, the control unit 11 compares the first detection temperature and the second detection temperature, and determines whether the deviation between them is less than or equal to the setting value X. Note that, in this embodiment, the setting value X is set to 20 degrees.

In step 105, when the deviation between the first detection temperature and the second detection temperature is less than or equal to the setting value X of 20 degrees, in step 107, the control unit 11 determines that the engine 1 had been operated immediately before, stops the start assist operation, and prevents the start assist operation from being executed.

Here, the reason for the determination by the control unit 11 is that a temperature difference occurs between the first detection temperature and the second detection temperature during the operation of the engine 1 or immediately after the engine 1 is stopped, and that when the engine 1 has been left for a predetermined long time after being stopped, there is almost no temperature difference between the first detection temperature and the second detection temperature.

More specifically, it has been found from the result of a verification test that, since the first thermistor A is close to the engine 1, which is a heat source, the temperature rise is fast and the detected maximum temperature is high. On the other hand, since the second thermistor B is farther from the engine 1 and is affected by wind generated by the rotor of the engine 1 and other effects, the temperature rise is gentler and slower, and the detected maximum temperature is lower as compared with the first thermistor A.

Therefore, in a case where it is determined that the deviation between the first detection temperature and the second detection temperature is less than or equal to the setting value X of 20 degrees, the control unit 11 determines that the engine 1 has been operated immediately before, i.e., the engine 1 is sufficiently warmed up and an increase in the amount of fuel is unnecessary.

Accordingly, the control unit 11 stops the start assist operation and controls so that the start assist operation is not executed.

On the other hand, in a case where it is determined in step 105 that the deviation between the first detection temperature and the second detection temperature is greater than the setting value X of 20 degrees, the control unit 11 executes the start assist operation in step 109.

That is, the control unit 11 controls the start control solenoid 9 to operate the start control valve of the carburetor 5 to be opened to automatically increase the fuel concentration of the air-fuel mixture to perform the start assist.

Note that, after the start assist operation has been performed in step 109, the process returns to step 103.

Then, the control unit 11 acquires the first detection temperature detected by the first thermistor A and the second detection temperature detected by the second thermistor B, and in step 105, the control unit 11 compares the first detection temperature and the second detection temperature again.

Then, the control unit 11 determines whether the deviation between the first detection temperature and the second detection temperature is less than or equal to the setting value X. In a case where it is determined that the deviation is less than or equal to the setting value X of 20 degrees, the control unit 11 determines in step 107 that the engine 1 has been operated immediately before and stops the start assist operation.

In addition, in a case where it is determined in step 105 that the deviation is greater than the setting value X of 20 degrees, the control unit 11 continues the start assist operation in step 109.

As described above, by controlling the stop and continuation of the start assist operation on the basis of the deviation between the first detection temperature and the second detection temperature, components such as the rotational speed detection unit conventionally required to determine whether to continue the start assist operation become unnecessary. As a result, the start control device can be configured more simply.

As described above, according to the embodiment of the present invention, the first thermistor A, which detects the first detection temperature, is disposed at a location susceptible to the temperature of the engine 1, and the second thermistor B, which detects the second detection temperature, is disposed at a location less susceptible to the temperature of the engine 1. The control unit 11 determines whether the deviation between the first detection temperature and the second detection temperature is less than or equal to the setting value X, and when the deviation is less than or equal to the setting value X, the control unit 11 stops the start assist operation. Accordingly, unnecessary execution of the start assist can be reliably prevented with a simple configuration.

Note that although the present embodiment has been described, the description and the drawings that form part of this disclosure should not be construed as limiting. Various embodiments and the like not described herein are included.

That is, in the present invention, the control of the ignition timing can be achieved by controlling the stop and continuation of the start assist operation on the basis of the deviation between the first detection temperature and the second detection temperature.

Accordingly, the present invention is not limited to the start assist by the start control device and can be applied to any engine control.

In the present embodiment, the stop of the start assist operation is determined solely based on whether the deviation between the first detection temperature and the second detection temperature is less than or equal to the setting value X. However, this determination may also be made in combination with other means, such as a rotational speed detection means, a start timing advance sensor, or a throttle valve sensor.

Further, in the present embodiment, the two temperature detection means, namely the first and second thermistors, are provided on the control board 21. However, three or more temperature detection means may also be provided.

For example, when three thermistors are provided, in addition to the first and second thermistors, a third thermistor may be disposed at a position where the temperature is approximately intermediate between those of the first and second thermistors.

In this case, a temperature difference between the temperature detected by the first thermistor disposed at the high-temperature location and the temperature detected by the third thermistor disposed at the intermediate-temperature location is monitored. Alternatively, a temperature difference between the temperature detected by the second thermistor disposed at the low-temperature location and the temperature detected by the third thermistor is monitored. Then, control is performed to prevent the fuel supply when both of these temperature differences are greater than or equal to a certain value.

Alternatively, for example, when three thermistors are provided, the first and second thermistors may be disposed at two different low-temperature positions, and the third thermistor may be disposed at a position with a higher temperature than the positions of the first and second thermistors.

In this case, a temperature difference between the temperature detected by the third thermistor disposed at the high-temperature location and the temperature detected by the first thermistor disposed at the low-temperature location is monitored. Alternatively, a temperature difference between the temperature detected by the second thermistor disposed at the low-temperature location and the temperature detected by the third thermistor disposed at the high-temperature location is monitored. Then, control is performed to prevent the fuel supply when both of these temperature differences are greater than or equal to a certain value.

1. An engine control device that performs fuel control for an engine, the device comprising: at least two temperature detection means disposed on a control board for engine fuel control.

2. The engine control device according to claim 1, wherein the two temperature detection means are disposed apart from each other on the control board.

3. An engine fuel control device comprising: a first temperature detection means that is disposed at a location susceptible to a temperature of an engine and detects a first detection temperature; a second temperature detection means that is disposed at a location less susceptible to the temperature of the engine and detects a second detection temperature; and a control means that performs fuel control for the engine based on a relationship between the first detection temperature and the second detection temperature, wherein the first temperature detection means and the second temperature detection means are disposed apart from each other on a control board for engine fuel control.

4. The engine fuel control device according to claim 3, wherein the control means performs the fuel control for the engine based on a deviation between the first detection temperature and the second detection temperature.

5. The engine fuel control device according to claim 4, wherein a first distance between the first temperature detection means and the engine is shorter than a second distance between the second temperature detection means and the engine.

6. The engine fuel control device according to claim 4, wherein a fuel control amount is decreased or stopped when the deviation between the first detection temperature and the second detection temperature is less than or equal to a predetermined value.

7. The engine fuel control device according to claim 4, wherein, when the deviation between the first detection temperature and the second detection temperature is less than or equal to a predetermined value, in addition to fuel control, an ignition timing advance amount is reduced or switching is performed such that ignition is performed in a normal ignition timing mode.
